(19) United States
(12) Patent Application Publication
(10) Pub. No.: US 2017/0032397 A1
(43) Pub. Date: Feb. 2, 2017

(54) METHODS AND SYSTEMS FOR CONDUCTING AN ASSESSMENT

(71) Applicant: CULTURE COUNTS PTY. LTD., Wembley Downs, Western Australia (AU)

(72) Inventor: Michael Chappell, Wembley Downs (AU)

(21) Appl. No.: 15/301,033

(22) PCT Filed: Mar. 31, 2015
(86) PCT No.: PCT/IB2015/001105

§ 371 Date: Sep. 30, 2016

(30) Foreign Application Priority Data
Apr. 1, 2014 (AU) 2014/901173

(51) Int. Cl. G06Q 30/02; G06Q 40/06

(52) U.S. Cl. CPC G06Q 30/0203; G06Q 40/06

(57) ABSTRACT

In an aspect, first intrinsic information relating to an event can be received in advance of a beginning of the event. First extrinsic information relating to the event can be received in advance of the beginning of the event. Second intrinsic information relating to the event can be received subsequent to the beginning of the event. Optionally, second extrinsic information relating to the event can be received subsequent to the beginning of the event. Impact metrics can be generated from the received first intrinsic information, the received first extrinsic information, the received second intrinsic information, and the received second extrinsic information. The generated impact metrics can be outputted.

### CROSS REFERENCE TO RELATED PATENT APPLICATION

This application claims priority to Australian Pat. App. No. 2014/901173 filed Apr. 1, 2014, herein incorporated by reference in its entirety.

### SUMMARY

It is to be understood that both the following general description and the following detailed description are exemplary and explanatory only and are not restrictive. Provided are methods and systems for gathering feedback and assessing outcomes. In an aspect, an outcome can be measured intrinsically (e.g., intangibly) and extrinsically (e.g., tangibly). Many items can be assessed, including events, places, health environments, designs, programs and courses, or anything with one or more intrinsic components and one or more extrinsic components. Event assessments are a part of the platform's capability. The platform can also assess places, health environments, built form design, programs and courses, or anything that has both tangible and intangible (or intrinsic and extrinsic) components. For example, a public place can be assessed. In assessing the public place, the tangible components could comprise the number of park benches, the proportion of shaded areas in the public realm and number of rest rooms for example (each of which are measureable extrinsically by empirical observation); and the intangible components could comprise the degree of comfort felt by visitors, engagement with the place, stimulation of memories and other feelings for example (measured intrinsically by surveying the opinions of the visitors, designers or funders of the project). In another example, an in-patient's experience at a hospital can be measured. In assessing the in-patient's experience at a hospital, the tangible could be the pulse, blood pressure, oxygen saturation or time taken to complete a procedure for example (extrinsically measureable); and the intangible could be the patients' sense of wellbeing, mood or satisfaction with the treatment outcome (intrinsically measured). In another example, a participant's experience attending or being part of a program or course can be measured. In assessing the participant's experience at a program or course, the tangible could be the person's test outcomes of the course or program content, the outcomes of value or number of purchases made of course materials or program offers during the course or program or thereafter, or the regularity of attendance for example (extrinsically measureable); and the intangible could be the participant's sense of achievement in participating in or completing the program or course, their mood or satisfaction with the course or program learning or other outcomes (intrinsically measured). In another aspect, when an event (such as a show, a stay at a place, a meal at a restaurant, or any other event) is being assessed is relevant, as measurements can be taken before, during and after the event (e.g., episodic measurements). In an aspect, assessments can be taken repeatedly over a period of time (e.g., continuous measurement, longitudinal measurement, etc.)

In an aspect, first intrinsic information relating to an event, episode or other thing can be received in advance of a beginning of the event, episode or other thing (see episodic versus longitudinal variants of measurement methods described above). Extrinsic information relating to the event can be received at any time and may be received at multiple times before, during or after the event. Second intrinsic information relating to the event can be received subsequent to the beginning of the event. Impact metrics can be generated from the received first intrinsic information, the received extrinsic information, and the received second intrinsic information. Third and subsequent intrinsic information can be received during, or after the event. All or some of the generated impact metrics can be outputted for analysis or further survey.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a block diagram of an exemplary system;

FIG. 2 is a flow chart of an exemplary method;

FIG. 3 is a block diagram of an exemplary computing device;

FIG. 4 illustrates relationships generated through use of the disclosed methods and systems, and the synergy thus created;

FIG. 5 illustrates a database table before and after a keyword is added to an associated dimension; and

FIG. 6 is a flow chart of an exemplary method.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The present disclosure relates to allowing for assessments of outcomes. Many items can be assessed, including events, places, health environments, designs, programs and courses, or anything with one or more intrinsic components and one or more extrinsic components. Assessments can be based on expectations before the event or another thing that has intrinsic and extrinsic impact on a person; including the longitudinal assessment of a place or other thing, feedback regarding perceptions of the event after the event begins, and measured extrinsic information about the event. For example, the methods and systems provided can collect expectations about safety before a concert, collect feedback regarding the perception of safety provided at the concert, and collect actual crime statistics from the concert. In an aspect, expectations, perceptions, and actual statistics can be mapped against each other to generate a number of impact metrics. Similar assessments of intrinsic and extrinsic outcomes can be made for places, health environments, designs, programs and courses, or anything with one or more intrinsic components and one or more extrinsic components.

There is a correlation between impact and value; value metrics can be obtained with the impact metrics. Value may use some extrinsic data on the cost of the event or thing, such as cost of security or any other measured aspect of providing an event or thing. In an aspect, impact/value metrics can be applicable to events, such as, for example, ticket sales. In an aspect, impact/value metrics can be applicable to a thing, such as a place. For example, walkability might be applicable to a particular place. In an aspect, impact/value metrics can be applicable to events and things. For example, safety can be a place metric or an event metric. The systems and methods described herein can contain libraries of intrinsic assessment dimensions that can be used for different applications. For instance, a city government could use the ‘event’ assessment library to assess the intrinsic and extrinsic impact of an event and the ‘place’ assessment library to assess the intrinsic and extrinsic impact of the place. It is also possible to use a combination of event and place metrics when assessing, say, an event at a local town hall. The town hall exists as a place permanently (hence it may be important to understand perceptions of its accessibility, convenience, comfort, capacity to support civic aspects of society, etc.); but the town hall also hosts concerts, about which the systems and methods described herein can gather feedback on the originality and other aspects of artistic quality. Additionally, the systems and methods described herein can gather feedback on the emotional stimulation of the audience as a result of the concert. Here, the city government could choose from both the ‘place’ library and the ‘event’ library to assess the impact of the concert.

For example, expectations about safety can be mapped against perceptions of safety and/or actual crime statistics. In another example, perceptions of safety can be mapped against actual crime statistics. In an aspect, the generated impact metrics can be outputted, for example, for display.

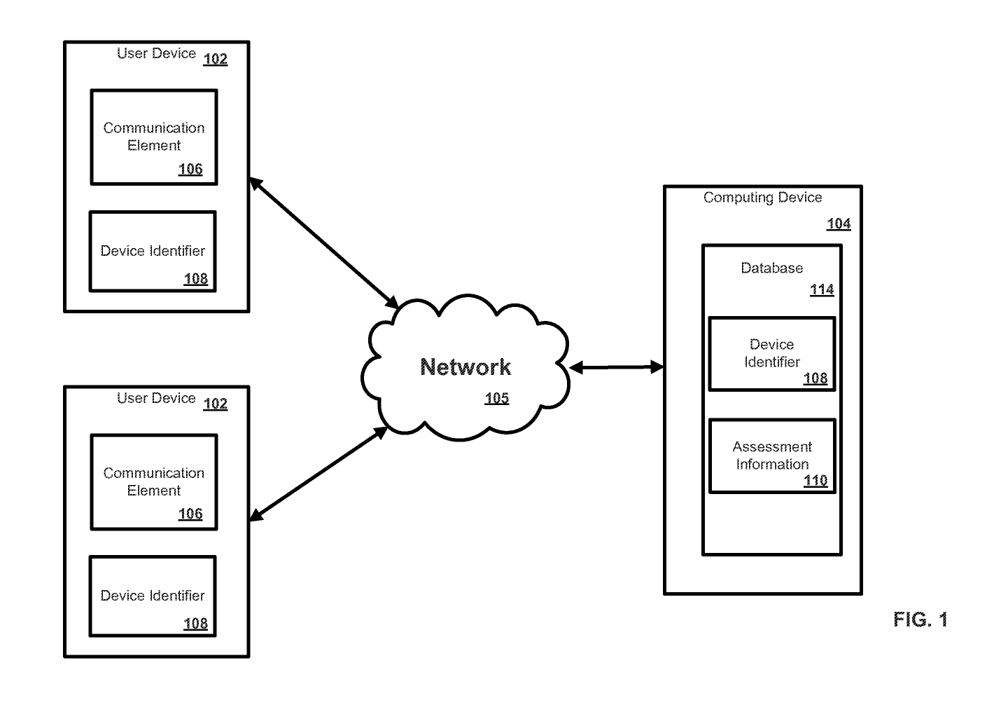

In one aspect of the disclosure, a system can be configured to provide services such as network-related services to a user device. FIG. 1 illustrates various aspects of an exemplary environment in which the present methods and systems can operate. The present disclosure is relevant to systems and methods for providing services to a device, for example, a user device such as a computer, tablet, mobile device, communications terminal, or the like. The network and system can comprise a user device 102 in communication with a computing device 104 such as a server, for example. The computing device 104 can be disposed locally or remotely relative to the user device 102. As an example, the user device 102 and the computing device 104 can be in communication via a private and/or public network 105 such as the Internet or a local area network. Other forms of communications can be used such as wired and wireless telecommunication channels, for example.

In an aspect, the user device 102 can be an electronic device such as a computer, a smartphone, a laptop, a tablet, a set top box, a display device, or other device capable of communicating with the computing device 104. As an example, the user device 102 can comprise a communication element 106 for providing an interface to a user to interact with the user device 102 and/or the computing device 104. The communication element 106 can be any interface for presenting and/or receiving information to/from the user, such as user feedback. An example interface may be communication interface such as a web browser (e.g., Internet Explorer®, Mozilla Firefox®, Google Chrome®, Safari®, or the like). Other software, hardware, and/or interfaces can be used to provide communication between the user and one or more of the user devices 102 and the computing device 104. As an example, the communication element 106 can request or query various files from a local source and/or a remote source. As a further example, the communication element 106 can transmit data to a local or remote device such as the computing device 104. In an aspect, the computing device 104 can request feedback from the one or more user devices 102. In an aspect, the feedback request can be in the form of a questionnaire. In a further aspect, the questionnaire can be provided via the communication element 106.

In an aspect, the user device 102 can be associated with a user identifier or device identifier 108. As an example, the device identifier 108 can be any identifier, token, character, string, or the like, for differentiating one user or user device (e.g., user device 102) from another user or user device. In a further aspect, the device identifier 108 can identify a user or user device as belonging to a particular class of users or user devices. As a further example, the device identifier 108 can comprise information relating to the user device such as a manufacturer, a model or type of device, a service provider associated with the user device 102, a state of the user device 102, a locator, and/or a label or classifier. Other information can be represented by the device identifier 108.

In an aspect, the device identifier 108 can comprise or provide an internet protocol address, a network address, a media access control (MAC) address, an Internet address, or the like. As an example, the device identifier 108 can be relied upon to establish a communication session between the user device 102 and the computing device 104 or other devices and/or networks. As a further example, the device identifier 108 can be used as an identifier or locator of the user device 102.

In an aspect, the computing device 104 can manage the communication between the user device 102 and a database 114 for sending and receiving data therebetween. As an example, the database 114 can store a plurality of files (e.g., web pages), user identifiers or records, or other information. As a further example, the user device 102 can request and/or retrieve a file from the database 114. In an aspect, the database 114 can store information relating to the user device 102 such as assessment information 110. As an example, the computing device 104 can pair the device identifier 108 from the user device 102 and the assessment information 110 provided from the user device 102 via the communication element 106. Any information can be stored in and retrieved from the database 114. The database 114 can be disposed remotely from the computing device 104 and accessed via direct or indirect connection. The database 114 can be integrated with the computing system 104 or some other device or system.

The assessment information 110 can comprise any information for measuring any kind of assessment or feedback for an event, including feedback from participants of the event, expectations from future participants of the event, collected objective facts about the event, environmental information surrounding the event, any other type of information for assessing an event, or any combination of the foregoing.

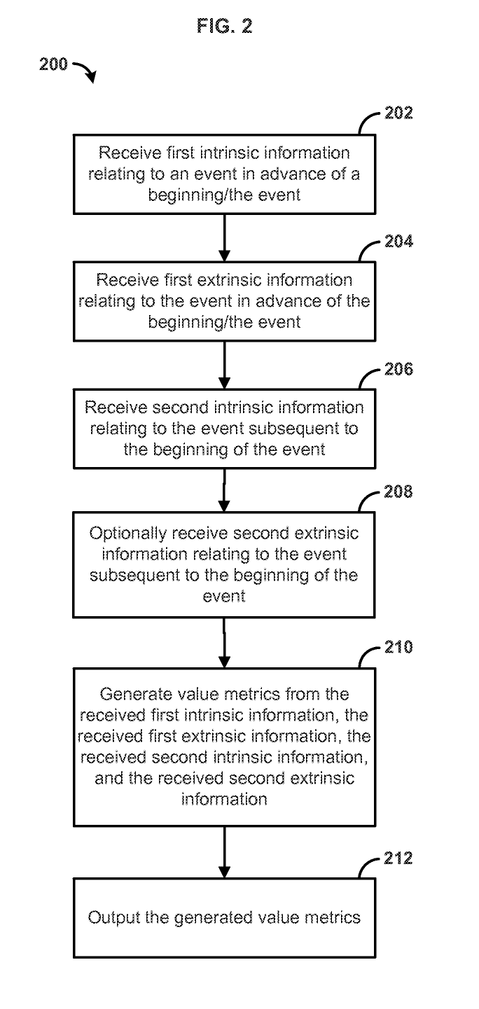

FIG. 2 is a flowchart illustrating an example method 200. At 202, first intrinsic information relating to an event or thing can be received in advance of a beginning of an event, course or program or in advance of the beginning of an encounter with the place, design or other thing. In an aspect, the first intrinsic information can comprise answers from a first questionnaire, feedback mechanism or assessment. In an aspect, the first questionnaire can be provided to a user device. In an aspect, one of a plurality of demographics can be determined. In a further aspect, the first questionnaire can be selected from a plurality of questionnaires. In a further aspect, selection of the first questionnaire can be based on the determined demographic. In a further aspect, the plurality of demographics can comprise organizers, vendors, and/or visitors.

At 204, first extrinsic information relating to the event or thing can be received in advance of the beginning of the event. In an aspect, steps 202 and 204 can be performed simultaneously. In an aspect, the received first extrinsic information can be observable fact. For example, the received first extrinsic information can be financial information, such as budgeted and actual ticket sales, budgeted and actual merchandise sales, budgeted and actual philanthropic contributions, sponsorships, profit, earned income, funded income, etc. Earned income is by the ‘sweat of the brow’ of the subject organizations (e.g., ticket sales, sponsorships and donations) and funded income is government or private finance for ongoing operations, often in the form of periodic grant. In another example, the received first extrinsic information can be statistics, such as pedestrian counts, crime statistics, number of car parking spaces, number of park benches, medical data, etc. In yet another example, the received first extrinsic information can be social impact, such as a number of messages related to the event, or thing, included on social media, a number of positive messages related to the event, or thing, included on social media, a number of negative messages related to the event, or thing, included on social media, etc. In yet another example, the received first extrinsic information can be biometric feedback from a sensor attached to a human's body that captures heart rate, perspiration, body temperature, breathing rate or other biological measurements. In an aspect, the received first extrinsic information can be any other observable fact related to the event, or thing. In an aspect, the received first extrinsic information can be any combination of the foregoing. In an aspect, first extrinsic data can be received as input from an operator. In an aspect, first extrinsic data can be received electronically via a Web-based application and/or a Web tool. In a further aspect, the Web-based application and/or the Web tool can provide an application-programming interface (API) for communication with other applications.

At 206, second intrinsic information relating to an event can be received subsequent to the beginning of the event. In an aspect, the second intrinsic information can comprise answers from a second questionnaire. In an aspect, the first questionnaire can be the same as the second questionnaire. In an aspect, the first questionnaire can be different from the second questionnaire. In an aspect, the second questionnaire can be provided to a user device. In an aspect, one of a plurality of demographics can be determined. In a further aspect, the second questionnaire can be selected from a plurality of questionnaires. In a further aspect, selection of the second questionnaire can be based on the determined demographic. In a further aspect, the plurality of demographics can comprise organizers, vendors, and/or visitors. In an aspect, the first intrinsic information and the second intrinsic information can relate to security. In a further aspect, the extrinsic information can comprise crime data. In an aspect, the first intrinsic information and the second intrinsic information can relate to emotional state. In a further aspect, the extrinsic information can comprise medical data. In an aspect, the first intrinsic information and the second intrinsic information can relate to a sense of community. In a further aspect, the extrinsic information can comprise a number of park benches and/or pedestrian counts. In an aspect, the first intrinsic information and the second intrinsic information can relate to satisfaction with an event. In a further aspect, the extrinsic information can comprise budgeted and/or actual ticket sales.

Optionally, at 208, second extrinsic information relating to an event can be received subsequent to the beginning of the event. In some aspects, 208 is not optional. In an aspect, steps 206 and 207 can be performed simultaneously. In an aspect, the received second extrinsic information can be observable fact. For example, the received second extrinsic information can be financial information, such as budgeted and actual ticket sales, budgeted and actual merchandise sales, budgeted and actual philanthropic contributions, sponsorships, profit, earned income, funded income, etc. Earned income is by the ‘sweat of the brow’ of the subject organizations (e.g., ticket sales, sponsorships and donations) and funded income is government or private finance for ongoing operations, often in the form of periodic grant. In another example, the received second extrinsic information can be statistics, such as pedestrian counts, crime statistics, number of car parking spaces, number of park benches, medical data, etc. In yet another example, the received second extrinsic information can be social impact, such as a number of messages related to the event, or thing, included on social media, a number of positive messages related to the event, or thing, included on social media, a number of negative messages related to the event, or thing, included on social media, etc. In yet another example, the received second extrinsic information can be biometric feedback from a sensor attached to a human's body that captures heart rate, perspiration, body temperature, breathing rate or other biological measurements. In an aspect, the received second extrinsic information can be any other observable fact related to the event, or thing. In an aspect, the received second extrinsic information can be any combination of the foregoing. In an aspect, second extrinsic data can be received as input from an operator. In an aspect, second extrinsic data can be received electronically via a Web-based application and/or a Web tool. In a further aspect, the Web-based application and/or the Web tool can provide an application-programming interface (API) for communication with other applications.

At 210, impact metrics can be generated from the received first intrinsic information, the received first extrinsic information, the received second intrinsic information, and/or the received second extrinsic information. Optionally, impact metrics can be generated for users in a group. In an aspect, the group can be one of: organizers, vendors, and visitors. In an aspect, the group can represent a perspective of the systems and methods described herein. In an aspect, the group and/or perspective can be one of: self, peer, and public. In an aspect, “self” can be designated for the organization or individual that pays a subscription fee. In an aspect, “self” can comprise funders, stakeholders, the government, etc. In an aspect, “peer” can be designated for those with some knowledge of the outputs(s) of the organization. In an aspect, “public” can be designated for the ultimate consumer of the event or the user of the place, thing, or service. In an aspect, the impact metrics can be created for each of the groups. In a further aspect, one of the impact metrics corresponding to a group can be compared and/or contrasted to another of the impact metrics corresponding to a second group. In an aspect, a subscriber (or user from the “self” perspective) can measure how improvements are received internally, by its peers, by the public or some other target group. For example, the systems and methods can measure the “Quality of Artistic Leadership” for a particular city and/or area in connection with the city and/or area bringing in an artistic exhibition. In an aspect, goals related to intrinsic impact can be set and/or measured for each individual perspective or group. In an aspect, input from each perspective can be simultaneously sourced, analyzed, and reported—this multiple-source input approach can be called “triangulation.” In an aspect, the generated impact metrics can comprise a return on investment, when considered along with the resources required to create the event or thing. In a further aspect, the return on investment can be an economic return on investment (measured in purely extrinsic, empirical terms). In another aspect, the return on investment can be a social return on investment. In a further aspect, the social return on investment can be based on an economic proxy. In another aspect, the social return on investment can be based on an index. An index can be created by taking the current generated impact for a dimension (e.g., feeling of safety in a place) and comparing the current generated impact for the dimension against a baseline measurement (for example, the generated impact for the dimension of the feeling of safety from a year previous). In a further aspect, the baseline index can be based on observed social media behavior. In another aspect, the baseline index can be based on a sampling of similarly situated events, places, things, or services. In another aspect, the baseline index can be based on a similarly situated event, place, thing, or service.

At 212, the generated impact metrics can be outputted, for example, for display. In an aspect, the generated impact metrics can be conditioned for display on one or more of the user devices 102. In another aspect, the generated impact metrics can be outputted for display on a central computing device 104. In an aspect, the generated impact metrics can be conditioned for printing on paper. In an aspect, the generated impact metrics can be outputted audibly. In an aspect, the generated impact metrics can be outputted tactilely.

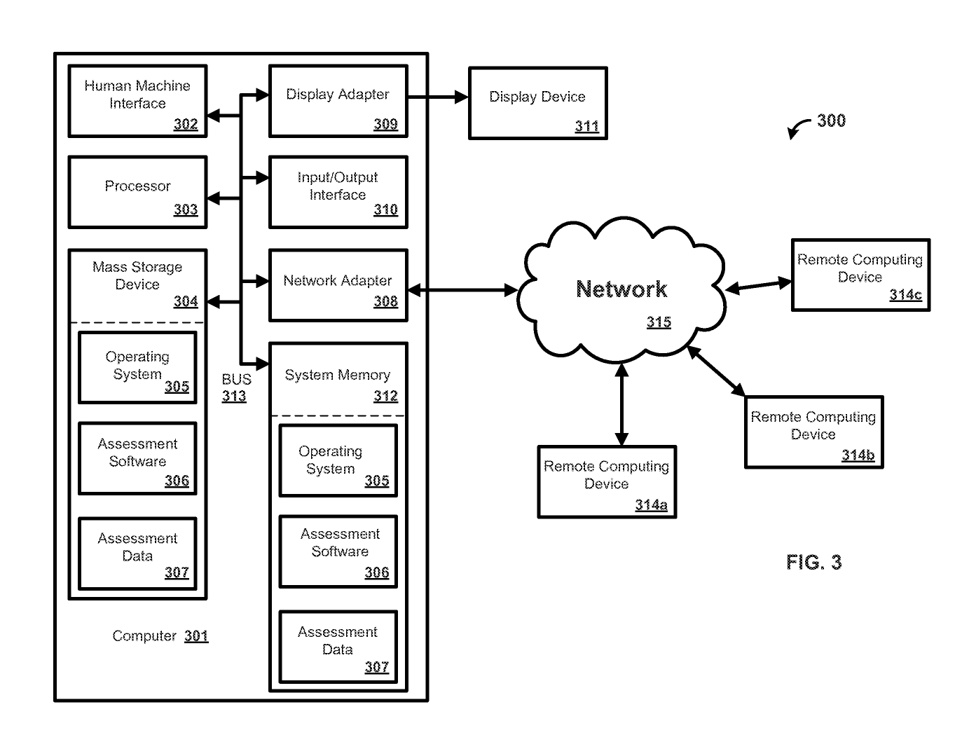

In an exemplary aspect, the methods and systems can be implemented on a computer 301 as illustrated in FIG. 3 and described below. By way of example, server 110 of FIG. 1 can be a computer 301 as illustrated in FIG. 3. Similarly, the methods and systems disclosed can utilize one or more computers to perform one or more functions in one or more locations. FIG. 3 is a block diagram illustrating an exemplary operating environment 300 for performing the disclosed methods. This exemplary operating environment 300 is only an example of an operating environment and is not intended to suggest any limitation as to the scope of use or functionality of operating environment architecture. Neither should the operating environment 300 be interpreted as having any dependency or requirement relating to any one or combination of components illustrated in the exemplary operating environment 300.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage media including memory storage devices.

Further, one skilled in the art will appreciate that the systems and methods disclosed herein can be implemented via a general-purpose computing device in the form of a computer 301. The computer 301 can comprise one or more components, such as one or more processors 303, a system memory 312, and a bus 313 that couples various components of the computer 301 including the one or more processors 303 to the system memory 312. In the case of multiple processors 303, the system can utilize parallel computing.

The bus 313 can comprise one or more of several possible types of bus structures, such as a memory bus, memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 313, and all buses specified in this description can also be implemented over a wired or wireless network connection and one or more of the components of the computer 301, such as the one or more processors 303, a mass storage device 304, an operating system 305, assessment software 306, assessment data 307, a network adapter 308, system memory 312, an Input/Output Interface 310, a display adapter 309, a display device 311, and a human machine interface 302, can be contained within one or more remote computing devices 314a,b,c at physically separate locations, connected through buses of this form, in effect implementing a fully distributed system.

The computer 301 typically comprises a variety of computer readable media. Exemplary readable media can be any available media that is accessible by the computer 301 and comprises, for example and not meant to be limiting, both volatile and non-volatile media, removable and non-removable media. The system memory 312 can comprise computer readable media in the form of volatile memory, such as random access memory (RAM), and/or non-volatile memory, such as read only memory (ROM). The system memory 312 typically can comprise data such as assessment data 307 and/or program modules such as operating system 305 and assessment software 306 that are accessible to and/or are operated on by the one or more processors 303.

In another aspect, the computer 301 can also comprise other removable/non-removable, volatile/non-volatile computer storage media. The mass storage device 304 can provide non-volatile storage of computer code, computer readable instructions, data structures, program modules, and other data for the computer 301. For example, a mass storage device 304 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 304, including by way of example, an operating system 305 and assessment software 306. One or more of the operating system 305 and assessment software 306 (or some combination thereof) can comprise elements of the programming and the assessment software 306. Assessment data 307 can also be stored on the mass storage device 304. Assessment data 307 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple locations within the network 315.

In another aspect, the user can enter commands and information into the computer 301 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like. These and other input devices can be connected to the one or more processors 303 via a human machine interface 302 that is coupled to the bus 313, but can be connected by other interface and bus structures, such as a parallel port, game port, an IEEE 1394 Port (also known as a Firewire port), a serial port, network adapter 308, and/or a universal serial bus (USB).

In yet another aspect, a display device 311 can also be connected to the bus 313 via an interface, such as a display adapter 309. It is contemplated that the computer 301 can have more than one display adapter 309 and the computer 301 can have more than one display device 311. For example, a display device 311 can be a monitor, an LCD (Liquid Crystal Display), light emitting diode (LED) display, television, smart lens, smart glass, and/ or a projector. In addition to the display device 311, other output peripheral devices can comprise components such as speakers (not shown) and a printer (not shown) which can be connected to the computer 301 via Input/Output Interface 310. Any step and/or result of the methods can be output in any form to an output device. Such output can be any form of visual representation, including, but not limited to, textual, graphical, animation, audio, tactile, and the like. The display 311 and computer 301 can be part of one device, or separate devices.

The computer 301 can operate in a networked environment using logical connections to one or more remote computing devices 314a,b,c. By way of example, a remote computing device 314a,b,c can be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the computer 301 and a remote computing device 314a,b,c can be made via a network 315, such as a local area network (LAN) and/or a general wide area network (WAN). Such network connections can be through a network adapter 308. A network adapter 308 can be implemented in both wired and wireless environments. Such networking environments are conventional and commonplace in dwellings, offices, enterprise-wide computer networks, intranets, and the Internet.

For purposes of illustration, application programs and other executable program components such as the operating system 305 are illustrated herein as discrete blocks, although it is recognized that such programs and components can reside at various times in different storage components of the computing device 301, and are executed by the one or more processors 303 of the computer 301. An implementation of assessment software 306 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence (AI) techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

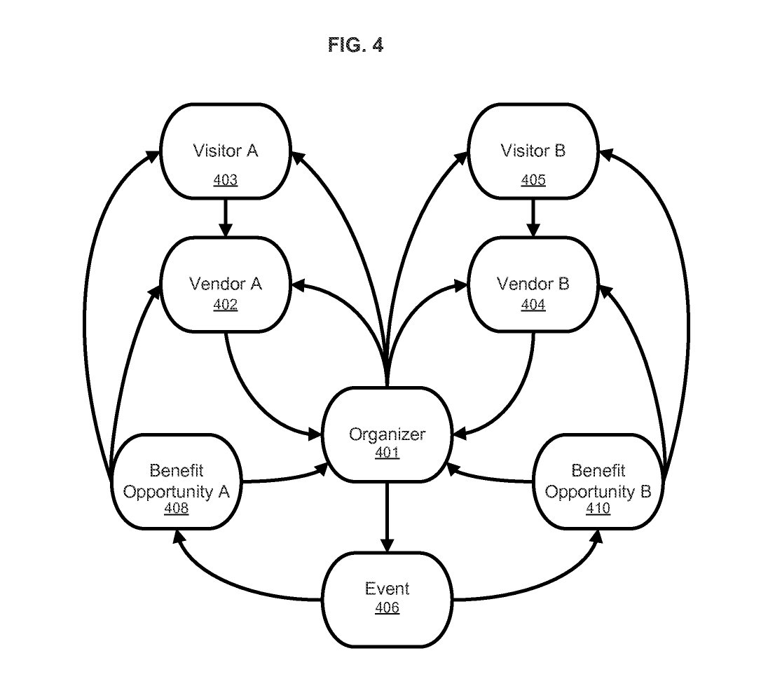

FIG. 4 illustrates relationships generated through use of the disclosed methods and systems, and the synergy thus created. An entity, such as Organizer 401, creates a relationship with a Vendor, such as Vendor A 402 and Vendor B 404. The Organizer 401 additionally creates a relationship with Visitors, such as Visitor A 403 and Visitor B 405. The Organizer 401 can create an Event, such as Event 406. Using the systems and methods described herein, the Organizer 401 can improve the Event 406 so that Vendor A 402 experiences a Benefit Opportunity, such as Benefit Opportunity A 408 and Vendor B 404 experiences a Benefit Opportunity, such as Benefit Opportunity B 410. Additionally, using the systems and methods described herein, the Organizer 401 can improve the Event 406 so that Visitor A 405 experiences a Benefit Opportunity, such as Benefit Opportunity A 408 and Visitor B 404 experiences a Benefit Opportunity, such as Benefit Opportunity B 410. Through these relationships and using the systems and methods described herein, Organizer 401 can identify a value opportunity. The value opportunity can be to the Organizer 401, one or more Vendors 402, 404, one or more Visitors 403, 405, or any combination of the foregoing. Through the efforts of Organizer 401, Vendor A 402 and Vendor B 404 derive benefit from Benefit Opportunity A 408 and Benefit Opportunity B 410, whereby Organizer 401 is provided with a fee in the form of monies. The fee can allow Vendor A 402 and/or Vendor B 404 to attend the Event 406 as a Vendor. Through the efforts of Organizer 401, Visitor A 402 and Visitor B 404 derive benefit from Benefit Opportunity A 408 and Benefit Opportunity B 410, whereby Organizer 401 is provided with a fee in the form of monies. The fee can allow Visitor A 402 and/or Visitor B 404 to attend the Event 406 as a Visitor. The Vendors 402, 404 and the Visitors 403, 405 can inform the Organizer 401 of what was liked and disliked about the Event 406, allowing the Organizer 401 to make future Events more appealing to Vendors 402, 404 and Visitors 403, 405. Likewise, because the Organizer 401 can make the future Events more appealing, the Organizer 401 can charge the Vendors 402, 404 and Visitors 403, 405 more to attend future Events.

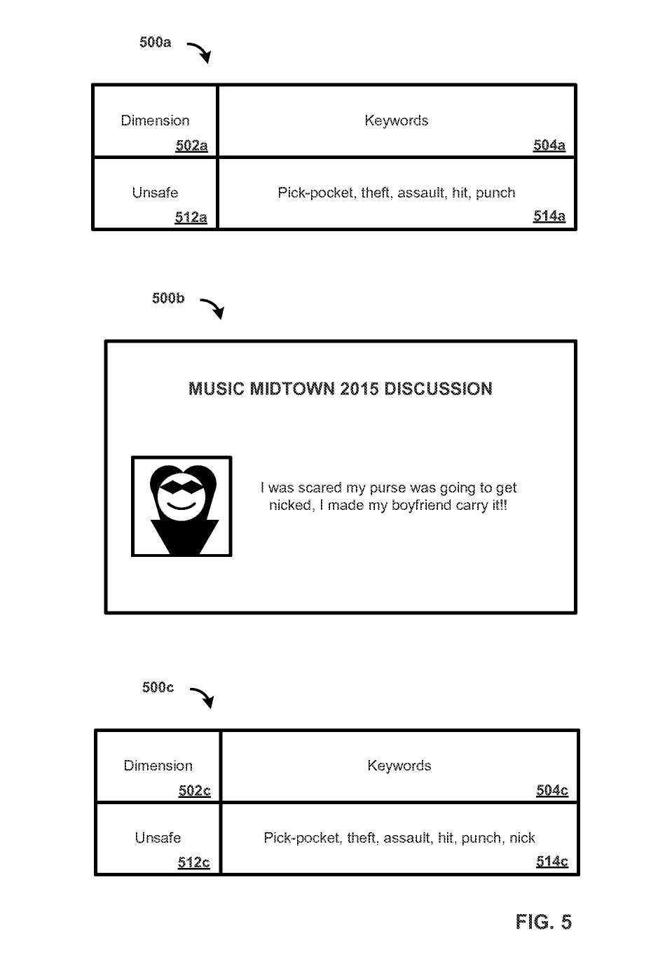

FIG. 5 illustrates an exemplary system. Table 500a associates dimensions 502a with keywords 504a. In an aspect, keywords 504a can be synonyms of a dimension 502a. In an aspect, keywords 504a can be types of a dimension 502a. As an example, the dimension “Unsafe” 512a is associated with the keywords “pick-pocket,” “theft,” “assault,” “hit,” and “punch” 514a. In an aspect, table 500a can initially be populated by feedback from relevant users of the systems and methods described herein. For example, managers can be interviewed to determine which dimensions 502a the managers would be interested in learning about for a particular event, place, or thing. Similarly, the interviews with the managers can be used to determine which keywords 504a should be associated with a chosen dimension 502a. After initial creation, the tables 500a can be maintained through cultivation by the users of the systems and methods described herein. In an aspect, the systems and methods can scan social media correspondences for the keywords 514a and associate any social media correspondence with one of the keywords 514a with the Unsafe dimension 512a. In an aspect, a process called stemming can be used to convert variant forms of a word into its base form. The methods and systems described herein can perform stemming on social media correspondences. For example, “punches” and “punching” appearing in social media correspondences can be converted to “punch,” before comparison with the keywords 514a. Mentions of a dimension 502a or the keywords 504a associated with the dimension 502a in social media correspondences can be collected for presentation. Presentation can comprise outputting a report. Mentions of a dimension 502a or the keywords 504a associated with the dimension 502a in social media correspondences can be counted. If a particular dimension 502a receives a number of mentions above a threshold within a window of time, the particular dimension can be considered trending.

An exemplary social media correspondence is illustrated in 500b. In the social media correspondence 500b, the user is discussing a matter that would fit under the Unsafe dimension 512a. However, the social media correspondence 500b does not use any of the keywords 514a. The systems and methods described herein recognize that the social media correspondence 500b should be associated with the dimension “Unsafe” 512a. The systems and methods described herein determine that “nick” is the word from the social media correspondence 500b that should be added to the list of keywords 514a. In an aspect, a user can add “nick” to the list of keywords 514a associated with the user's account. In a further aspect, the list of keywords 514a can be updated globally for all user accounts. In a further aspect, the globally updating of all user accounts can happen in response to an administrator adopting the addition to the list of keywords 514a. In a further aspect, the globally updating of all user accounts can happen in response to a vote from users on whether the addition to the list of keywords 514a should be applied globally. In an aspect, the results of the vote can be published to all users. In a further aspect, voting can be continuous and the global list can be dynamically updated in real-time in response to voting. In an aspect, if a keyword is mentioned more than a predetermined threshold, then the keyword can be considered for replacement of the dimension. In an aspect, if a keyword is mentioned more than a predetermined threshold, then the keyword can be considered for creation of an independent dimension. Consideration for dimension replacement or dimension creation can comprise voting by users and/or administration approval. In an aspect, the methods of keyword maintenance can be performed for all users or any subset of users (e.g., a children's theatre group subset.)

Table 500c links dimensions 502c with keywords 504c. Table 500c shows table 500a after “nick” is added to the keywords 514c associated with dimension “Unsafe” 512c. From now on, when a social media correspondence mentions “nick,” the social media correspondence will be associated with the dimension “Unsafe” 512c.

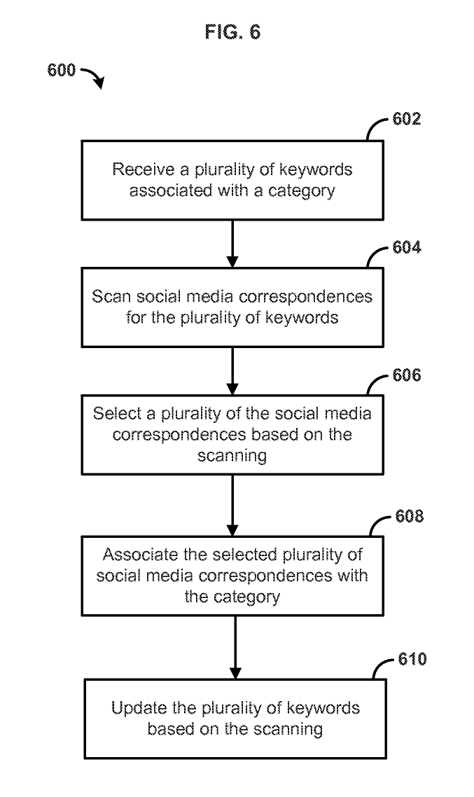

FIG. 6 is a flowchart illustrating an example method 600. At 602, a plurality of keywords associated with a dimension is received. In an aspect, the plurality of keywords can be entered by a user.

At 604, social media correspondences can be scanned for the plurality of keywords. In an aspect, each social media correspondence can be examined as it is posted. In an aspect, the posted social media correspondences can be scraped at a regular interval. At 606, a plurality of the social media correspondences can be selected based on the scanning In an aspect, a social media correspondence can be selected if it comprises a keyword associated with the dimension.

At 608, the selected plurality of social media correspondences can be associated with the dimension. In an aspect, when a user seeks to retrieve information regarding the dimension, the selected plurality of social media correspondences can be included in the information sought for retrieval. At 610, the plurality of keywords can be updated based on the scanning

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
receiving first intrinsic information relating to an event in advance of a beginning of the event;
receiving first extrinsic information relating to the event in advance of the beginning of the event;
receiving second intrinsic information relating to the event subsequent to the beginning of the event;
generating impact metrics from the received first intrinsic information, the received first extrinsic information, and the received second intrinsic information; and
outputting the generated impact metrics.

2. The method of claim 1, wherein the first intrinsic information comprises answers from a first questionnaire.

3. The method of claim 2, wherein the second intrinsic information comprises answers from a second questionnaire and wherein the first questionnaire is the same as the second questionnaire.

4. The method of claim 1, wherein the first intrinsic information and the second intrinsic information relate to security and wherein the first extrinsic information and the second extrinsic information comprise crime data.

5. The method of claim 1, the first intrinsic information and the second intrinsic information relate to emotional state and wherein the first extrinsic information and the second extrinsic information comprise medical data.

6. The method of claim 1, wherein the generated impact metrics comprise a return on investment.

7. The method of claim 6, wherein the return on investment is an economic return on investment.

8. The method of claim 6, wherein the return on investment is a social return on investment.

9. The method of claim 8, wherein the social return on investment is based on an economic proxy.

10. The method of claim 8, wherein the social return on investment is based on a baseline index.

11. The method of claim 1, wherein generating impact metrics further comprises generating impact metrics for users in a group, wherein the group is one of: an organizer, a vendor, and a visitor.

12. The method of claim 1, further comprising receiving second extrinsic information relating to the event subsequent to the beginning of the event.

13. The method of claim 12, wherein generating impact metrics is further based on the received second extrinsic information

14. A system comprising:
memory; and
a processor, configured to:
receive first intrinsic information relating to an event in advance of a beginning of the event;
receive first extrinsic information relating to the event in advance of the beginning of the event;
receive second intrinsic information relating to the event subsequent to the beginning of the event;
generate impact metrics from the received first intrinsic information, the received extrinsic information, and the received second intrinsic information; and
output the generated impact metrics.

15. The system of claim 14, wherein the first intrinsic information comprises answers from a first questionnaire.

16. The system of claim 15, wherein the second intrinsic information comprises answers from a second questionnaire and wherein the first questionnaire is the same as the second questionnaire.

17. The system of claim 14, wherein the generated impact metrics comprise a return on investment.

18. The system of claim 17, wherein the return on investment is an economic return on investment.

19. The system of claim 17, wherein the return on investment is a social return on investment.

20. The system of claim 19, wherein the social return on investment is based on an economic proxy.

21. The system of claim 19, wherein the social return on investment is based on a baseline index.

22. The system of claim 14, wherein the processor is further configured to receive second extrinsic information relating to the event subsequent to the beginning of the event.

23. The system of claim 22, wherein the processor is further configured generate impact metrics based on the received second extrinsic information

24. A non-transitory computer-readable medium configured to perform the steps of:
receiving first intrinsic information relating to an event in advance of a beginning of the event;
receiving first extrinsic information relating to the event in advance of the beginning of the event;
receiving second intrinsic information relating to the event subsequent to the beginning of the event;
generating impact metrics from the received first intrinsic information, the received first extrinsic information, the received second intrinsic information, and the received second extrinsic information; and
outputting the generated impact metrics.
